(19) United States
(12) Patent Application Publication
(10) Pub. No.: US 2014/0315036 A1
(43) Pub. Date: Oct. 23, 2014

(54) Ultraviolet-curable Resin Composition, Cured Product, and Optical Member

(71) Applicant: Nippon Kayaku KabushikaKaisha, Chiyoda-ku, Tokyo (JP)

(72) Inventors: Daisuke Kobayashi, Tokyo (JP); Hayato Motohashi, Tokyo (JP); Yuichiro Matsuo, Tokyo (JP)

(73) Assignee: NIPPON KAYAKU KABUSHIKIKAISHA, Chiyoda-ku, Tokyo (JP)

(21) Appl. No.: 14/357,250

(22) PCT Filed: Nov. 8, 2012
(86) PCT No.: PCT/JP2012/007158

§ 371 Date: May 9, 2014

(30) Foreign Application Priority Data
Nov. 9, 2011 (JP) 2011-245158

(51) Int. Cl. G02B 1/04; B32B 7/12

(52) U.S. Cl. CPC G02B 1/04; B32B 7/12
USPC 428/522; 522/33; 525/330.3

(57) ABSTRACT

The present invention relates to an optical member fabricated by laminating together at least two substrates by means of a cured product layer of an ultraviolet-curable resin composition containing (A) a (meth)acrylic polymer having a weight average molecule weight of 1,500 to 30,000, (B) a (meth)acrylate compound having a (meth)acrylic equivalent of 200 g/eq. or more and having at least two (meth)acryloyl groups, and (C) a photopolymerization initiator, and an ultraviolet-curable resin composition for laminating together at least two substrates, and is useful as an optical transparent adhesive exhibiting high curability, allowing for lesser shrinkage during curing, and being excellent in the transparency of the cured product as well as in the adhesiveness to a substrate and the flexibility.

### TECHNICAL FIELD

The present invention relates to an ultraviolet-curable resin composition useful for laminating optical substrates together.

### BACKGROUND ART

In recent years, a display device with a touch panel, which is fabricated by combining a display device such as liquid crystal display, plasma display and organic EL display with a position input device such as touch panel, is being widely utilized. This display device with a touch panel has a structure where a glass plate or resin-made film (for example, a touch panel) having a transparent electrode formed thereon and a glass-made or resin-made transparent protective plate are laminated on a display device.

In a display device with a touch panel, for the lamination between a display device and a glass plate or film having formed thereon a transparent electrode or/and a glass- or resin-made transparent protective plate, a technique using a double-aided pressure-sensitive adhesive sheet is known, but this technique has a problem that an air bubble is likely to be entrained. As a technique substituting for the double-sided pressure-sensitive adhesive sheet, a lamination technique using a photocurable resin composition has been proposed (Patent Documents 1 to 3).

On the other hand, the display device is becoming thinner or larger-screened. For example, thinning of the transparent protective plate may be associated with a problem that the touch panel is deformed due to shrinkage on curing during lamination using a photocurable resin composition. Also, when the adherend material differs from the glass/acrylic resin or the glass/polycarbonate resin, the difference in the thermal expansion or hygroscopicity therebetween may bring about a problem that the adhesive surface is separated in a wet heat resistance test or the glass is broken. In order to solve these problems, a photocurable resin composition capable of suppressing shrinkage during curing and giving a cured product excellent in the adhesiveness to a substrate as well as in the flexibility is demanded, but a satisfactory resin composition has not been obtained in Patent Documents 1 to 3.

### BACKGROUND ART DOCUMENT

### Patent Document

Patent Document 1: International Publication No. 2010/027041

Patent Document 2: JP-A-2010-248387 (the term “JP-A” as used herein means an “unexamined published Japanese patent application”)

Patent Document 3: JP-T-2011-511851 (the term “JP-T” as used herein means a published Japanese translation of a PCT patent application)

### SUMMARY OF INVENTION

### Problem That Invention is to Solve

An object of the present invention is to provide an ultraviolet-curable resin composition useful as an optical transparent adhesive exhibiting high curability, allowing for lesser shrinkage during curing, and being excellent in the transparency of the cured product m well as in the adhesiveness to a substrate and the flexibility, and an optical member fabricated by laminating together at least two substrates by means of the ultraviolet-curable resin composition.

### Means For Solving Problem

As a result of many intensive studies to solve those problems, the present inventors have found that the above-described object can be attained by an ultraviolet-curable resin composition containing a (meth)acrylic polymer having a weight average molecule weight of 1,500 to 30,000 and a (meth)acrylic compound having a (meth)acrylic equivalent of 200 g/eq. or more and having two or more (meth)acryloyl groups. The present invention has been accomplished based on this finding.

That is, the present invention relates to the following (1) to (7).

(1) An optical member, fabricated by laminating at least two substrates together by means of a cured product layer of an ultraviolet-curable resin composition containing (A) a (meth)acrylic polymer having a weight average molecule weight of 1,500 to 30,000, (B) a (meth)acrylate compound having a (meth)acrylic equivalent of 200 g/eq. or more and having at least two (meth)acryloyl groups, and (C) a photopolymerization initiator.

(2) The optical member as described in (1) above,

wherein a shrinkage percentage on curing of the ultraviolet-curable resin composition is 3% or less.

(3) The optical member as described in (1) or (2) above,

wherein the ultraviolet-curable resin composition gives a cured product having a flexibility value of less than 20 as measured by a Type E durometer.

(4) The optical member as described in any one of (1) to (3) above,

wherein the (meth)acrylic polymer (A) is a (meth)acrylic polymer obtained by polymerizing monomers containing at least one monomer selected from alkyl (meth)acrylates having a carbon number of 1 to 10, which may have a hydroxy group.

(5) The optical member as described in any one of (1) to (4) above,

wherein the (meth)acrylate compound (B) is a di(meth)acrylate having caprolactone modification or a poly C3-C4 alkylene glyol di(meth)acrylate.

(6) The optical member as described in any one of (1) to (5) above,

wherein the (meth)acrylic polymer (A) is a (meth)acrylic polymer obtained by polymerizing monomers containing at least one monomer selected from alkyl (meth)acrylates having a carbon number of 1 to 10, which may have a hydroxy group, and

the (meth)acrylate compound (B) is a di(meth)acrylate having caprolactone modification or a poly C3-C4 alkylene glycol di(meth)acrylate.

(7) The optical member as described in any one of (1) to (6) above,

wherein the (meth)acrylic polymer (A) is a (meth)acrylic polymer obtained by polymerizing at least one monomer selected from the group consisting of methyl (meth)acrylate, n-butyl (meth)acrylate, 2-ethylhexyl (meth)acrylate, octyl (meth)acrylate, 2-hydroxyethyl (meth)acrylate and hydroxybutyl (meth)acrylate, and

the (meth)acrylate compound (B) is at least one compound selected from the group consisting of caprolactone-modified hydroxypivalic acid neopentyl glycol diacrylate, polypropylene glycol diacrylate and polytetramethylene glycol diacrylate.

(8) The optical member as described in any one of (1) to (7) above,

wherein the ultraviolet-curable resin composition is a resin composition containing, based on the entire composition, from 48 to 92 wt % of the (meth)acrylic polymer (A), from 5 to 40 wt % of the (meth)acrylate compound (B) and from 3 to 12 wt % of the photopolymerization initiator (C).

(9) An ultraviolet-curable resin composition, which is used to laminate at least two substrates together and comprises:

(A) a (meth)acrylic polymer having a weight average molecule weight of 1,500 to 30,000;

(B) a (meth)acrylate compound having a (meth)acrylic equivalent of 200 g/eq. or more and having at least two acryloyl groups; and

(C) a photopolymerization initiator.

(10) The ultraviolet-curable resin composition as described in (9) above, which is an ultraviolet-curable resin composition having a shrinkage percentage on curing of 3% or less.

(11) The ultraviolet-curable resin composition as described in (9) or (10) above, which gives a cured product having a flexibility value of less than 20 as measured by a Type E durometer.

(12) The ultraviolet-curable resin composition as described in any one of (9) to (11) above, which gives a cured product having a shrinkage percentage on curing of 3% or less and a flexibility value of less than 20 as measured by a Type E durometer.

(13) The ultraviolet-curable resin composition as described in any one of (9) to (12) above,

wherein the (meth)acrylic polymer (A) is a (meth)acrylic polymer obtained by polymerizing at least one monomer selected from alkyl (meth)acrylates having a carbon number of 1 to 10, which may have a hydroxy group, and

the (meth)acrylate compound (B) is a di(meth)acrylate having caprolactone modification or a poly C3-C4 alkylene glycol di(meth)acrylate.

(14) The ultraviolet-curable resin composition as described in any one of (9) to (13) above,

wherein the (meth)acrylic polymer (A) is a (meth)acrylic polymer obtained by polymerizing at least one monomer selected from the group consisting of methyl (meth)acrylate, n-butyl (meth)acrylate, 2-ethylhexyl (meth)acrylate, octyl (meth)acrylate, 2-hydroxyethyl (meth)acrylate and hydroxybutyl (meth)acrylate.

(15) The ultraviolet-curable resin composition as described in any one of (9) to (14) above,

wherein the (meth)acrylate compound (B) is at least one compound selected from the group consisting of caprolactone-modified hydroxypivalic acid neopentyl glycol diacrylate, polypropylene glycol diacrylate and polytetramethylene glycol diacrylate.

(16) The ultraviolet-curable resin composition as described in any one of (9) to (15) above,

wherein the (meth)acrylic polymer (A) is a (meth)acrylic polymer obtained by polymerizing at least one monomer selected from the group consisting of methyl (meth)acrylate, n-butyl (meth)acrylate, 2-ethylhexyl (meth)acrylate, octyl (meth)acrylate, 2-hydroxyethyl (meth)acrylate and hydroxybutyl (meth)acrylate, and

the (meth)acrylate compound (B) is at least one compound selected from the group consisting of caprolactone-modified hydroxypivalic acid neopentyl glycol diacrylate, polypropylene glycol diacrylate and polytetramethylene glycol diacrylate.

(17) The ultraviolet-curable resin composition as described in any one of (9) to (16) above, which is a resin composition containing, based on the entire composition, from 48 to 92 wt % of the (meth)acrylic polymer (A), from 5 to 40 wt % of the (meth)acrylate compound (B) and from 3 to 12 wt % of the photopolymerization initiator (C).

(18) The ultraviolet-curable resin composition as described in any one of (9) to (17) above,

wherein a content of the (meth)acrylic polymer (A) is from 70 to 95 wt % based on the entire composition.

(19) The ultraviolet-curable resin composition as described in any one of (9) to (18) above,

wherein a content of the (meth)acrylic polymer (B) is from 10 to 30 wt % based on the entire composition,

(20) The ultraviolet-curable resin composition as described in any one of (9) to (19) above,

wherein a content of the (meth)acrylic polymer (A) is from 70 to 95 wt % based on the entire composition and a shrinkage percentage on curing is 3.0% or less.

(21) A cured product, obtained by irradiating the ultraviolet-curable resin composition as described in any one of (9) to (20) above with an active energy ray.

(22) A touch panel, fabricated by laminating at least two substrates together by means of a cured product of the ultraviolet-curable resin composition as described in any one of (9) to (20) above.

(23) A display device with a touch panel, wherein at least two substrates are laminated together by means of a cured product of the ultraviolet-curable resin composition as described in any one of (9) to (20) above.

### Advantage of the Invention

According to the present invention, an ultraviolet-curable resin composition useful as an optical transparent adhesive exhibiting high curability, allowing for lesser shrinkage during curing, and being excellent in the transparency of the cured product as well as in the adhesiveness to a substrate and the flexibility, and an optical member fabricated by laminating together at least two substrates by means of the ultraviolet-curable resin composition can be provided.

### MODE FOR CARRYING OUT THE INVENTION

The ultraviolet-curable resin composition used for laminating together at least two substrates of the present invention (hereinafter, sometimes simply referred to as the resin composition of the present invention) contains (A) a (meth)acrylic polymer having a weight average molecule weight of 1,500 to 30,000, (B) a (meth)acrylate compound having a (meth)acrylic equivalent of 200 g/eq. or more and having two or more (meth)acryloyl groups, and (C) a photopolymerization initiator.

The (meth)acrylic polymer (A) contained in the resin composition includes a polymer obtained by polymerizing an acrylic or methacrylic monomer (hereinafter, referred as (meth)acrylic monomer) as a raw material, and a copolymer of the (meth)acrylic monomer above and other polymereizble monomers except for a (meth)acrylic monomer. The copolymer includes a copolymer where a (meth)acrylic monomer-derived component is preferably the main component of the polymer and more preferably accounts for 40 mole % to less than 100 mol %, still more preferably accounts for 50 mol % to less than 100 mol %, based on the total molar number of monomer-derived components of all monomers constituting the copolymer. The polymer most preferred as the (meth)acrylic polymer (A) is a homopolymer or copolymer obtained by polymerizing a (meth)acrylic monomer not containing a component other than a (meth)acrylic monomer.

The (meth)acrylic polymer (A) can be produced by polymerizing a monomer mixture containing at least one (meth)acrylic monomer by a normal method such as solution polymerization, suspension polymerization and bulk polymerization.

The particularly preferred production method includes continuous radical polymerization at a high temperature. Specifically, the polymer is produced by the following process. First, a (meth)acrylic monomer (and, if desired, other polymerizable monomers except for a (meth)acrylic monomer), a small amount of a polymerization initiator, and a small amount of a solvent are mixed. Next, the mixture is reacted at a temperature of 150° C. or more for 10 minutes or more under high pressure. Subsequently, the (meth)acrylic polymer obtained by the reaction is separated from unreacted components by means of a separator, whereby the target polymer can be obtained.

When a polymerization initiator is mixed in the target polymer, the storage stability may be poor. Therefore, it is preferred to perform the reaction while distilling off the solvent or distil off the solvent after the (meth)acrylic polymer is obtained by separation.

The (meth)acrylic monomer used as the raw material of the (meth)acrylic polymer (A) includes an alkyl (meth)acrylate that may be substituted with an alkoxy group, a dialkyl-substituted amino group, a hydroxy group, a phenyl group, a benzyl group, and the like. Examples thereof include a (meth)acrylic acid, an α-ethylacrylic acid, and an ester-based (meth)acrylate such as methyl (meth)acrylate, n-propyl (meth)acrylate, isopropyl (meth)acrylate, n-butyl (meth)acrylate; sec-butyl (meth)acrylate, tert-butyl (meth)acrylate; 2-ethylbutyl (meth)acrylate, 1,3-dimetylbutyl (meth)acrylate, hexyl (meth)acrylate, 2-ethylhexyl (meth)acrylate, octyl (meth)acrylate, 3-ethoxypropyl (meth)acrylate, 3-etoxybutyl (meth)acrylate, dimethylaminoethyl (meth)acrylate, 2-hydroxyethyl (meth)acrylate, hydroxybutyl (meth)acrylate, α-(hydroxymethyl)ethyl (meth)acrylate, phenyl (meth)acrylate, benzyl (meth)acrylate and phenylethyl (meth)acrylate. One of these monomers or two or more thereof may be used.

The (meth)acrylic polymer (A) may be a polymer where the entire polymer is formed by polymerizing the (meth)acrylic monomer, or a polymer where the polymer partially contains a component derived from a monomer other than the (meth)acrylic monomer.

As other polymerizable monomers except for the (meth)acrylic monomer, which may be copolymerized, known compounds having an unsaturated double bond can be used, and examples thereof include styrene, 3-nitrostyrene, 4-methoxystyrene; alkylstyrenes such as α-methylstyrene, β-methylstyrene, 2,4-dimethylstyrene, vinyltoluene, α-ethylstyrene, α-butylstyrene and α- hexylstyrene; halogenated styrenes such as 4-chlorostyrene, 3-chlorostyrene and 3-bromostyrene; and carboxylic acids having an unsaturated double bond, such as crotonic acid α-methylcrotonic acid, α-ethylcrotonic acid, isocrotonic acid, maleic acid, fumaric acid, itaconic acid, citraconic acid, mesaconic acid and glutaconic acid.

Among these, in view of solubility in other components of the composition and the adhesiveness of the cured product, the acrylic or methacrylic monomer (in the description of the present invention, referred to as (meth)acrylic monomer) for the (meth)acrylic polymer (A) is preferably an alkyl (meth)acrylate having a carbon number of 1 to 10, which may have a hydroxy group. The alkyl (meth)acrylate having a carbon number of 1 to 10, which may have a hydroxy group, includes a hydroxy-substituted C1-C10 alkyl (meth)acrylate, and an unsubstituted C1-C10 alkyl (meth)acrylate. Examples thereof include a C1-C10 alkyl (meth)acrylate such as methyl (meth)acrylate, n-butyl (meth)acrylate, 2-ethylhexyl (meth)acrylate and octyl (meth)acrylate, and a hydroxyl group-containing C1-C10 alkyl (meth)acrylate such as 2-hydroxyethyl (meth)acrylate and hydroxybutyl (meth)acrylate. The other polymerizable monomer except for the (meth)acrylic monomer is preferably styrene or the like.

The (meth)acrylic polymer (A) is preferably a polymer where the (meth)acrylic monomer-derived component accounts for 40 to 100 mol %, more preferably from 60 to 100 mol %, still more preferably from 80 to 100 mol %, based on the total molar number of components derived from monomers constituting the polymer, and most preferably a polymer whom the (meth)acrylic monomer-derived components accounts for 100 mol % (hereinafter, sometimes referred to as (meth)acrylate polymer).

The (meth)acrylic polymer (A) preferably contains no (meth)acryloyl group in the terminal and the like.

In the present invention, the weight average molecular weight of the (meth)acrylic polymer (A) is from 1,500 to 30,000, preferably from 3,000 to 20,000, more preferably from 5,000 to 15,000. If the average molecular weight is too small, the cured product tends to have poor adhesiveness, whereas if the weight average molecular weight is too large, the polymer may disadvantageously become less dissolvable in other monomers or become white turbid.

The (meth)acrylic polymer (A) may be easily available also as a commercial product. Examples thereof include “ARUFON Series” produced by Toagosei Co., Ltd., which are available as UP-1170, UH-2190, and the like.

The weight ratio (the ratio to the total amount of the resin composition of the present invention; hereinafter the same) of the component (A) in the resin composition of the present invention is usually from 20 to 95 wt %, preferably from 50 to 95 wt %, more preferably on the order of 70 to 95 wt %, still more preferable from 70 to 90 wt %. If the weight ratio is too small, the adhesiveness is poor, and if the weight ratio is too large, the curability deteriorates. The remainder is composed of the component (B) and the component (C).

In addition, it is also preferred that the content of the component (A) is from 48 to 92 wt % based on the total amount of the resin composition of the present invention.

The (B) (meth)acrylate compound having a (meth)acrylic equivalent of 200 g/eq. or more and having two or more (meth)acryloyl groups, which is contained in the resin composition of the present invention, is preferably a (meth)acrylate compound having a (meth)acrylic equivalent of 200 g/eq. or more and having two (meth)acryloyl groups (hereinafter, sometimes referred to as the di(meth)acrylate compound). The di(meth)acrylate compound is preferably a glycol di(meth)acrylate having caprolactone modification or a poly C3-C4 alkylene glycol di(meth)acrylate. Specifically, these compounds include caprolactone-modified hydroxypivalic acid neopentyl glycol diacrylate (KAYARAD HX-220, produced by Nippon Kayaku Co., Ltd., (meth)acrylic equivalent: 270), caprolactone-modified hydroxypivalic acid neopeotyl glycol diacrylate (KAYARAD HX-620, produced by Nippon Kayaku Co., Ltd., (meth) acrylic equivalent: 384, KAYARAD HX-220, produced by Nippon Kayaku Co., Ltd., (meth)acrylic equivalent: 270), polypropylene glycol diacrylate (FANCRYL FA-P240A, produced by Hitachi Chemical Co., Ltd., (meth)acrylic equivalent: 267), polypropylene glycol diacrylate (FANCRYL FA-P270A, produced by Hitachi Chemical Co., Ltd., (meth)acrylic equivalent:412), polypropylene glycol diacrylate (FANCRYL FA-P2100A, produced by Hitachi Chemical Co., Ltd., (meth)acrylic equivalent: 555), polypropylene glycol diacrylate (FANCRYL FA-P2200A, produced by Hitachi Chemical Co., Ltd., (meth)acrylic equivalent: 1055), polytetramethylene glycol diacrylate (BLEMMER ADT-250, produced by NOF Corporation, (meth)acrylic equivalent: 207), polytetramethylene glycol dimethacrylate (for example, FANCRYL FA-PTG9A, produced by Hitachi Chemical Co., Ltd., (meth)acrylic equivalent: 379), and polyethylene oxide-modified bisphenol A diacrylate (for example, FANCRYL FA-321A, produced by Hitachi Chemical Co., Ltd., (meth)acrylic equivalent: 388). In view of close adhesion to an optical member, caprolactone-modified hydroxypivalic acid neopentyl glycol diacrylate (KAYARAD HX-620, produced by Nippon Kayaku Co., Ltd., (meth)acrylic equivalent: 384, KAYARAD HX-220, produced by Nippon Kayaku Co., Ltd., (meth)acrylic equivalent: 270), polypropylene glycol diacrylate (FANCRYL FA-P270A, produced by Hitachi Chemical Co., Ltd., (meth)acrylic equivalent: 412), polypropylene glycol diacrylate (FANCRYL FA-P2100A, produced by Hitachi Chemical Co., Ltd., (meth)acrylic equivalent: 555), polypropylene glycol diacrylate (FANCRYL FA-P2200A, produced by Hitachi Chemical Co., Ltd., (meth)acrylic equivalent: 1055), and polytetramethylene glycol dimethacrylate (for example, FANCRYL FA-PTG9A, produced by Hitachi Chemical Co., Ltd., (meth)acrylic equivalent: 379) are preferred. Among others, because of small shrinkage percentage on curing and excellent flexibility, caprolactone-modified hydroxypivalic acid neopetnyl glycol diacrylate (KAYARAD HX-620, produced by Nippon Kayaku Co., Ltd., (meth)acrylic equivalent: 384), polypropylene glycol diacrylate (FANCRYL FA-P270A, produced by Hitachi Chemical Co., Ltd., (meth)acrylic equivalent: 412), polypropylene glycol diacrylate (FANCRYL FA-P2100A, produced by Hitachi Chemical Co., Ltd., (meth)acrylic equivalent: 555), and polypropylene glycol diacrylate (FANCRYL FA-P2200A, produced by Hitachi Chemical Co., Ltd., (meth)acrylic equivalent: 1055) are more preferred.

Here, the (meth)acrylic equivalent of the (meth)acrylate compound (B) contained in the resin composition of the present invention is usually 200 g/eq. or more, preferably 300 g/eq. or more, more preferably 400 g/eq. or more.

If the (meth)acrylic equivalent is too high, this may affect the adhesiveness and the like. Therefore, usually, the (meth)acrylic equivalent is preferably 3,000 g/eq. or less, more preferably 2,000 g/eq. or less, still more preferably 1,500 g/eq. or less, and most preferably 1,200 g/eq. or less.

The (meth)acrylic equivalent of the (meth)acrylate compound (B) is preferably from 250 to 3,000 g/eq., more preferably from 300 to 1,500 g/eq. still more preferably on the order of 350 to 1,500 g/eq. and most preferably on the order of 350 to 1,200 g/eq.

The weight ratio of the component (B) in the resin composition of the present invention is usually from 5 to 40 wt %, preferably from 10 to 30 wt %, more preferably on the order of 15 to 25 wt %. If the weight ratio is too small, the curability is poor, and if the weight ratio is too large, the shrinkage increases.

The photopolymerization initiator (C) contained in the resin composition of the present invention is not particularly limited but includes, for example, 1-hydroxycyclohexyl phenyl ketone (IRGACURE 184; produced by BASF), 2-hydroxy-2-methyl-[4-(1-methylvinyl)phenyl]propanol oligomer (ONE; produced by Lamberti), 1-[4-(2-hydroxyethoxy)-phenyl]-2-hydroxy-2-methyl-1-propan-1-one (IRGACURE 2959; produced by BASF), 2-hydroxy-1-{4-[4-(2-hydroxy-2-methyl-propionyl)-benzyl]-phenyl}-2-methyl-propan-1-one (IRGACURE 127; produced by BASF), 2,2-dimethoxy-2-phenylacetophenone (IRGACURE 651; produced by BASF), 2-hydroxy-2-methyl-1-phenyl-propan-1-one (DAROCUR 1173; produced by BASF), 2-methyl-1-[4-(methylthio)phenyl]-2-morpholinopropan-1-one (IRGACURE 907; produced by BASF), 2-benzyl-2-dimethylamino-1-(4-morpholinophenyl)-butan-1-one, 2-chlorothioxanthone, 2,4-dimethylthioxanthone, 2,4-diisopropylthioxanthone, isopropylthioxanthone, 2,4,6-trimethylbenzoyldiphenylphosphine oxide, bis(2,4,6-trimethylbenzoyl)-phenylphosphine oxide, and bis(2,6-dimethoxybenzoyl)-2,4,4-trimethylpentylphosphine oxide. In view of transparency, 1-hydroxycyclohexyl phenyl ketone (IRGACURE 184; produced by BASF), 2-hydroxy-2-methyl-[4-(1-methylvinyl)phenyl]propanol oligomer (ESACURE KIP-150; produced by Lamberti), and methyl phenylglycoxylate (DAROCUR MBF; produced by BASF) are preferred. Also, from the standpoint of improving the internal curability of the adhesive, 2,4,6trimethylbenzoyldiphenylphosphine oxide (SPEEDCURE TPO; PRODUCED BY LAMBSON) is preferred.

In the resin composition of the present invention, one of these components (C) may be used, or two or more thereof may be mixed and used in an arbitrary ratio. The weight ratio of the component (C) in the resin composition is usually from 1 to 15 wt %, preferably from 2 to 12 wt %, more preferably from 3 to 12 wt %.

Furthermore, amines and the like which can work out to a photopolymerization initiator aid may also be used in combination. Amines and the like which can be used include 2-dimethylaminoethyl benzoate, dimethylaminoacetophenone, ethyl p-dimethylaminobenzoate, and isoamyl p-dimethylaminobenzoate. Usually, the polymerization initiator aid such as amines may not be used, but in the case of using the photopolymerization initiator aid, the content thereof in the resin composition of the present invention is usually from 0.005 to 5 wt %, preferably from 0.01 to 3 wt %.

The resin composition of the present invention may contain (D) a (meth)acrylate compound other than (B), as long as the characteristics of the present invention are not impaired. As the (meth)acrylate compound (D) other than (B), a (meth)acrylate having one or more (meth)acryloyl groups may be suitably used.

Incidentally, the (meth)acrylate as used in the present invention means methacrylate or acrylate.

The (meth)acrylate compound (D) other than the component (B) is not particularly limited in its kind as long as it is a (meth)acrylate compound not encompassed by the component (B). For example, (D-1) a urethane (meth)acrylate not encompassed by the component (B), (D-2) an epoxy (meth)acrylate not encompassed by the component (B), and (D-3) a (meth)acrylate monomer not encompassed by the component (B) can be used.

Here, the (meth)acrylate monomer (D-3) indicates, out of (meth)acrylates, a monomer excluding the (meth)acrylate compound (B), the urethane (meth)acrylate (D-1) and the epoxy (meth)acrylate (D-2).

The urethane (meth)acrylate (D-1) which can be contained in the resin composition of the present invention is obtained by reacting a polyhydric alcohol, a polyisocyanate, and a hydroxyl group-containing (meth)acrylate.

The polyhydric alcohol includes, for example, an alkylene glycol having a carbon number number of 1 to 10, such as neopentyl glycol, 3-methyl-1,5-pentanediol, ethylene glycol, propylene glycol, 1,4-butanediol and 1,6-hexanediol; a triol such as trimethylolpropane and pentaerythritol; an alcohol having a cyclic skeleton, such as tricycylodecanedimethylol and bis-[hydroxymethyl]-cyclohexane; a polyester polyol obtained by the reaction of such a polyhydric alcohol with a polybasic acid (such as succinic acid, phthalic acid, hexahydrophthalic anhydride, terephthalic acid, adipic acid, azelaic acid and tetrahydrophthalic anhydide; a caprolactone alcohol obtained by the reaction of the polyhydric alcohol with ε-caprolactone; a polycarbonate polyol (for example, a polycarbonate diol obtained by the reaction of 1,6-hexanediol with diphenyl carbonate); and a polyether polyol (such as polyethylene glycol, polypropylene glycol, polytetramethylene glycol, ethylene oxide-modified bisphenol A). Among others, in view of close adhesion to the substrate, a polypropylene glycol having a molecular weight of 2,000 or more is preferred.

The organic polyisocyanate includes, for example, isophorone diisocyanate, hexamethylene diisocyanate, tolylene diisocyanate, xylene diisocyanate, diphenylmethane-4,4′-diisocyante, and dicyclopentanyl isocyanate.

As the hydroxyl group-containing (meth)acrylate, for example, a hydroxy C2-C4 alkyl (meth)acrylate such as hydroxyethyl (meth)acrylate, hydroxypropyl (meth)acrylate and hydroxybutyl (meth)acrylate, a dimethylolcyclohexyl mono(meth)acrylate, and a hydroxycaprolactone (meth)acrylate can be used.

The reaction above is performed, for example, as follows. That is, an organic polyisocyanate is mixed with a polyhydric alcohol such that the isocyanate group of the organic polyisocyanate becomes preferably from 1.1 to 2.0 equivalent, more preferably from 1.1 to 1.5 equivalent per equivalent of the hydroxyl group of the polyhydric alcohol, and these are reacted at a reaction temperature of preferably from 70 to 90° C. to synthesize a urethane oligomer. Subsequently, a hydroxy (meth)acrylate compound is mixed therewith such that the hydroxyl group thereof becomes preferably from 1 to 1.5 equivalent per equivalent of the isocyanate group of the urethane oligomer, and these are reacted at 70 to 90° C., whereby the target urethane (meth)acrylate can be obtained.

The weight average molecular weight of the urethane (meth)acrylate (D-1) is preferably on the order of 500 to 25,000, more preferably from 700 to 10,000, still more preferably from 800 to 5,000. If the weight average molecular weight is too small, the shrinkage increases, whereas if the weight average molecular weight is too large, the curability becomes poor.

Usually, the resin composition of the present invention may not contain the component (D-1). As the component (D-1), one compound or an arbitrary mixture of two or more compounds may be used in a ratio of 0 to 90 wt % based on the total amount of the resin composition. The weight ratio of the component (D-1) in the resin composition of the present invention is usually from 5 to 90 wt %, preferably from 20 to 80 wt %, more preferably from 25 to 50 wt %.

In the resin composition of the present invention, (D-2) an epoxy (meth)acrylate can be used as long as the characteristics of the present invention are not impaired. Usually, the resin composition of the present invention may not contain the epoxy (meth)acrylate (D-2). The epoxy (meth)acrylate has a function of improving the curability or increasing the hardness or curing rate of the cured product and therefore, may be used, if desired. Also, any epoxy (meth)acrylate may be used as long as it is obtained by reacting a glycidyl ether-type epoxy compound with a (meth)acrylic acid, and the glycidyl ether-type epoxy compound for obtaining preferably used epoxy (meth)acrylate includes a diglycidyl ether of bisphenol A or its alkylene oxide adduct, a diglycidyl ether of bisphenol F or its alkylene oxide adduct, a diglycidyl ether of hydrogenated bisphenol A or its alkylene oxide adduct, a diglycidyl ether of hydrogenated bisphenol F or its alkylene oxide adduct ethylene glycol diglycidyl ether, propylene glycol diglycidyl ether, neopentyl glycol diglycidyl ether, butanediol diglycidyl ether, hexanediol diglycidyl ether, cyclohexanedimethanol diglycidyl ether, polypropylene glycol diglycidyl ether, and the like.

The epoxy (meth)acrylate is obtained by reacting such a glycidyl ether-type epoxy compound with a (meth)acrylic acid under the following conditions.

A (meth)acrylic acid is reacted in a ratio of 0.9 to 1.5 mol, preferably from 0.95 to 1.1 mol, per equivalent of the epoxy group of the glycidyl ether-type epoxy compound. The reaction temperature is preferably from 80 to 120° C., and the reaction time is approximately from 10 to 35 hours. In order to accelerate the reaction, it is also preferred to use a catalyst such as triphenylphosphine, TAP, triethanolamine and tetraethyl ammonium chloride. In addition, for example, paramethoxyphenol or methylhydroquinone may also be used as a polymerization inhibitor so as to prevent polymerization during the reaction.

The epoxy (meth)acrylate which can be preferably used in the present invention is a bisphenol A-type epoxy (meth)acrylate obtained from a bisphenol A-type epoxy compound. In the present invention, the weight average molecular weight of the epoxy (meth)acrylate (D-2) is preferably from 500 to 10,000.

In the resin composition of the present invention, as the component (D-2), one compound or a mixture of two or more compounds can be arbitrarily used in a ratio of 0 to 90 wt % based on the total amount of the resin composition. The content of the component (D-2) in the resin composition of the present invention may be 0, but in the case of using the component, the weight ratio thereof in the resin composition of the present invention is usually from 5 to 90 wt %, preferably from 20 to 80 wt %, more preferably from 25 to 50 wt %.

Here, in the case of using the epoxy (meth)acrylate from the standpoint of imparting flexibility to the cured product, the weight ratio in the resin composition of the present invention is preferably 20 wt % or less, more preferably 10 wt % or less, still more preferably 5 wt % or less.

The (meth)acrylate monomer (D-3) that is a (meth)acrylate usable as the (meth)acrylate (D) other than (B) is not particularly limited. For example, the (meth)acrylate monomer having one (meth)acryloyl group includes isooctyl (meth)acrylate, isoamyl (meth)acrylate, lauryl (meth)acrylate, isodecyl (meth)acrylate, stearyl (meth)acrylate, cetyl (meth)acrylate, isomyristyl (meth)acrylate, tridecyl (meth)acrylate, benzyl (meth)acrylate, tetrahydrofurfuryl (meth)acrylate, morpholine (meth)acrylate, phenyl glycidyl (meth)acrylate, 2-hydroxypropyl (meth)acrylate, ethoxydiethylene glycol, (meth)acrylate, tricyclyodecane (meth)acrylate, polypropylene glycol (meth)acrylate, polypropylene oxide-modified nonylphenyl (meth)acrylate, isoboryl (meth)acrylate, dicyclopentadiene oxyethyl (meth)acrylate, dicyclopentenyl acrylate (for example, FANCRYL FA-511A produced by Hitachi Chemical Co., Ltd.), dicyclopentenyloxyethyl acrylate (for example, FANCRYL FA-512A produced by Hitachi Chemical. Co., Ltd.), dicyclopentenyloxy methacrylate (for example, FANCRYL FA-512M produced by Hitachi Chemical Co., Ltd.), dicyclopentanyl acrylate (for example, FANCRYL FA-513A produced by Hitachi Chemical Co., Ltd.), dicyclopentanyl methacrylate (for example, FANCRYL FA-513M produced by Hitachi Chemical Co., Ltd.), 1-adamantyl acrylate (for example, Adamantate AA produced by Idemitsu Kosan Co., Ltd.), 2-methyl-2-adamantyl acrylate (for example, Adamantate MA produced by Idemitsu Kosan Co., Ltd.), 2-ethyl-2-adamantyl acrylate (for example, Adamantate EA produced by Idemitsu Kosan Co., Ltd.), 1-adamantyl methacrylate (for example, Adamantate AM produced by Idemitsu Kosan Co., Ltd.), ethylene oxide-modified phenoxylated phosphoric acid (meth)acrylate, ethylene oxide-modified butoxylated phosphoric acid (meth)acrylate, ethylene oxide-modified octyloxylated phosphoric acid (meth)acrylate, and the like.

The (meth)acrylate monomer having two (meth)acryloyl groups, which can be used as the (meth)acrylate monomer (D-3)), includes cyclohexane-1,4-dimethanol di(meth)acrylate, cyclohexane-1,3-dimethanol di(meth)acrylate, tricyclodecanedimethylol di(meth)acrylate (for example, KAYARAD R-684, tricyclodecanedimethylol diacrylate, produced by Nippon Kayaku Co., Ltd.), dioxane glycol di(meth)acrylate (for example, KAYARAD R-604, dioxane glycol diacrylate, produced by Nippon Kayaku Co., Ltd.), neopentyl glycol di(meth)diacrylate, dicyclopentanyl di(meth)acrylate, 1,6-hexanediol di(meth)acrylate, ethylene oxide-modified 1,6-hexanediol di(meth)acrylate, neopentyl glycol di(meth)diacrylate, alkylene oxide-modified neopentyl glycol di(meth)diacrylate, hydroxypivalic acid neopentyl glycol di(meth)acrylate, polyethylene glycol di(meth)acrylate, polypropylene glycol di(meth)acrylate, alkylene oxide-modified bisphenol A-type di(meth)acrylate, ethylene oxide-modified phosphoric acid di(meth)acrylate, and the like. Of these exemplary compounds, an exemplary compound of the generic concept, which may be encompassed by the component (B) (for example, propylene glycol di(meth)acrylate), means that the compound is a compound excluding the range encompassed by the component (B).

The resin composition of the present invention may contain a (meth)acrylate monomer having three or more (meth)acryloyl groups, other than the above-described (meth)acrylate having one or two (meth)acryloyl groups. Usually, the resin composition of the present invention may not contain this monomer. The monomer may be contained, if desired, and includes, for example, a trimethylol C2-C10 alkane tri(meth)acrylate such as trimethylolpropane tri(meth)acrylate and trimethyloloctane tri(meth)acrylate; a trimethylol C2-C10 alkane polyalkoxy tri(meth)acrylate such as trimethylolpropane polyethoxy tri(meth)acrylate, trimethylolpropane polypropoxy tri(meth)acrylate and trimethylolpropane polyethoxypolypropoxy tri(meth)acrylate; an alkylene oxide-modified trimethylolpropane tri(meth)acrylate such as tris[(meth)acroyloxyethyl]isocyanurate, pentaerythritol tri(meth)acrylate, ethylene oxide-modified trimethylolpropane tri(meth)acrylate and propylene oxide-modified trimethylolptopane tri(meth)acrylate; pentaerythritol polyethoxy tetra(meth)acrylate, pentaerythritol polypropoxy tetra(meth)acrylate, pentaerythritol tetra(meth)acrylate, ditrimethylolpropropane tetra(meth)acrylate, dipentaerythritol tetra(meth)acrylate, dipentaerythritol penta(meth)acrylate, and dipentaerythritol hexa(meth)acrylate.

Usually, the resin composition of the present invention may not contain the (meth)acrylate monomer (D-3) component. As this component, one compound or a mixture of two or more compounds in an arbitrary ratio may be used, if desired. The weight ratio of the component (D-3) in the ultraviolet-curable resin composition of the present invention is usually from 0 to 90 wt %, preferably from 0 to 50 wt %, more preferably from 0 to 30 wt %. Depending on the case, the weight ratio is from 5 to 90 wt %, preferably from 20 to 80 wt %, more preferably from 25 to 50 wt %.

In the ultraviolet-curable resin composition of the present invention, additives such as antioxidant, organic solvent, silane coupling agent, polymerization inhibitor, leveling agent, antistatic agent, surface lubricant, fluorescent brightening agent, light stabilizer (for example, a hindered amine compound) and filler may be added, if desired.

Specific examples of the antioxidant include BHT, 2,4-bis-(n-octylthio)-6-(4-hydroxy-3,5-di-tert-butylanilino)-1,3,5-triazine, pentaerythrityl·tetrakis[3-(3,5-di-tert-butyl-4-hydroxyphenyl)propionate], 2,2-thio-diethylenebis[3-(3,5-di-tert-butyl-4-hydroxyphenyl)propionate], triethylene glycol-bis[3-(3-tert-butyl-5-methyl-4-hydroxyphenyl)propionate], 1,6-hexanediol-bis[3-(3-tert-butyl-5-methyl-4-hydroxyphenyl)propionate], octadecyl-3-(3,5-di-tert-butyl-4-hydroxyphenyl)propionate, N,N-hexamethylenebis(3,5-di-tert-butyl-4-hydroxy-hydrocinnamide), 1,3,5-trimethyl-2,4,6-tris(3,5-di-tert-butyl-4hydroxybenzyl)benzene, tris-(3,5-di-tert-butyl-4-hydroxybenzyl)isocyanurate, octylated diphenylamine, 2,4-bis[(octylthio)methyl-O-cresol, isooctyl-3-(3,5-di-tert-butyl-4-hydroxyphenyl)propionate], and dibutylhydroxytoluene.

Specific examples of the organic solvent includes alcohols such as methanol, ethanol and isopropyl alcohol dimethylsulfone, dimethyl sulfoxide, tetrahydrofuran dioxane, toluene, and xylene.

Specific examples of the silane coupling agent include a silane-based coupling agent such as 3-glycidoxypropyltrimethoxysilane, 3-glycidoxypropylmethyldimethoxysilane, 3-glycidoxypropylmethyldimethoxysilane, 2-(3,4-epoxycyclohexyl)ethyltrimethoxysilane, N-(2-aminoethyl)3-aminopropylmethyldimethoxysilane, γ-mercapropropyltrimethoxysilane, N-2-aminoethyl)3-aminopropylmethyltrimethoxysilane, 3-aminopropyltriethoxysilane, 3-mercaptopropyltrimethoxysilane, vinyltrimethoxysilane, N-(2-(vinylbenzylamino)ethyl)3-aminopropyltrimethoxysilane hydrochloride, 3-methacryloxypropyltrimethoxysilane, 3-chloropropylmethydimethoxysilane and 3-chloropropyltrimethoxysilane; a titanium-based coupling agent such as isopropyl(N-ethylaminoethylamino)titanate, isopropyltriisostearoyl titanate, titanium di(dioctylpyrophosphate)oxyacetate, tetraisopropyldi(dioctylphosphite)titanate and neoalkoxytri(p-N-(β-aminoethyl)aminophenyl)titanate; and a zirconium- or aluminum-based coupling agent such as Zr-acetylacetonate, Zr-methacrylate, Zr-propionate, neoalkoxy zirconate, neoalkoxy trisneodecanoyl zirconate, noeoalkoxytris(dodecanoyl)benxenesulfonyl zirconate, neoalkoxytris(ethylenediaminoethyl)zirconate, neoalkoxytris(m-aminophenyl)zirconate, ammonium zirconium carbonate, Al-acetylacetonate, Al-methacrylate and Al-propionate.

Specific examples of the polymerization, inhibitor include paramethoxyphenol and methylhydroquinone.

Specific examples of the light stabilizer include a hindered amine-based compound such as 1,2,2,6,6-pentamethyl-4-piperidyl alcohol, 2,2,6,6-tetramethyl-4-piperidyl alcohol, 1,2,2,6,6-pentamethyl-4-piperidyl (meth)acrylate (LA-82 produced by ADEKA Corporation), tetrakis(1,2,2,6,6-pentamethyl-4-piperidyl)-1,2,3,4-butanetetracarboxylate, tetrakis(2,2,6,6-tetramethyl-4-piperidyl)-1,2,3,4-butanetetracarboxylate, a mixed esterification product of 1,2,3,4-butanetetracarboxylic acid with 1,2,2,6,6-pentamethyl-4-piperidinol and 3,9-bis(2-hydroxy-1,1-dimethylethyl)-2,4,8,10-tetraoxaspiro[5,5]undecane, decanedioic acid bis(2,2,6,6-tetramethyl-4-piperidyl)sebacate, bis(1-undecaneoxy-1,2,2,6,6-tetramethylpiperidin-4-yl)carbonate, 2,2,6,6-tetramethyl-4-piperidyl) methacrylate, bis(2,2,6,6-tetramethyl-4-piperidyl)sebacate, bis(1,2,2,6,6-pentamethyl-4-piperidyl)sebacate, 4-benzoyloxy-2,2,6,6-tetramethylpiperidine, 1-[2-[3-(3,5-di-tert-butyl-4-hydroxyphenyl)propionyloxy]ethyl]4-[3-(3,5-di-tert-butyl-4-hydroxyphenyl)propionyloxy]-2,2,6,6-tetramethylpiperidine, 1,2,2,6,6pentamethyl-4-piperidinyl-methacrylate, bis(1,2,2,6,6-pentamethyl-4-piperdinyl)[[3,5-bis(1,1-dimethylethyl)-4-hydroxyphenyl]methyl]butyl malonate, decanedioic acid bis(2,2,6,6-tetramethyl-1(octyloxy)-4-piperidinyl) ester, a reaction product of 1,1-dimethylethyl hydroperoxide and octane, N,N′,N″,N′″-tetrakis-(4,6-bis-(butyl-(N-methyl-bis(2,2,6,6-tetramethylpiperidin-4-yl)amino)-triazin-2-yl)-4,7-diazadecane-1,10-diamine, a polycondensate of dibutylamine·1,3,5-triazine·N,N′-bis(2,2,6,6-tetramethyl-4-piperidyl-1,6-hexamethylenediamine and N-(2,2,6,6-tetramethyl-4-piperidyl)butylamine, poly[[6-(1,1,3,3-tetramethylbutyl)amino-1,3,5-triazine-2,4-diyl][(2,2,6,6-tetramethyl-4-piperidyl)imino]hexamethylene[(2,2,6,6-tetramethyl-4-piperidyl)imino]], a polymerization product of dimethyl succinate and 4-hydroxy-2,2,6,6-tetramethyl-1-piperidine ethanol, 2,2,4,4-tetramethyl-20-(β-lauryloxycarbonyl)ethyl-7-oxa-3,20-diazadispiro[5·1·11·2]heneicosan-21-one, β-alanine, N,-(2,2,6,6-tetramethyl-4-piperidyl)-dodecyl ester/tetradecyl ester, N-acetyl-3-dodecyl-1-(2,2,6,6-tetramethyl-4-piperidyl)pyrrolidine-2,5-dione, 2,2,4,4-tetramethyl-7-oxa-3,20-diazadispiro[5,1,11,2]heneicosan-21-one, 2,2,4,4-tetramethyl-21-oxa-3,20-diazadicyclo-[5,1,11,2]-heneicosan-20-propanoic acid dodecyl ester/tetradecyl ester, propanedioic acid, [4-methoxyphenyl)-methylene]-bis(1,2,2,6,6-pentamethyl-4-piperidinyl) ester, a higher fatty acid ester of 2,2,6,6-tetramethyl-4-piperidinol, 1,3-benzenedicarboxyamide and N,N′-bis(2,2,6,6-tetramethyl-4-piperidyl); a benzophenone-based compound such as octabenzone; a benzotriazole-based compound such as 2-(2H-benzotriazole-2-yl)-4-(1,1,3,3-tetramethylbutyl)phenol, 2-(2-hydroxy-5-methylphenyl)benzotriazole, 2-[2-hydroxy-3-(3,4,5,6-tetrahydrophthalimido-methyl)-5-methylphenyl]benzotriazole, 2-(3-tert-butyl-2-hydroxy-5-methylphenyl)-5-chlorobenzotriazole, 2-(2-hydroxy-3,5-di-tert-pentylphenyl)benzotriazole, a reaction product of methyl 3-(3-(2H-benzotritriazol-2-yl)-5-tert-butyl-4-hydroxyphenyl)propionate and polyethylene glycol, and 2-(2H-benzotriazol-2-yl)-6-dodecyl-4-methylphenol; a benzoate-based compound such as 2,4-di-tert-butylphenyl-3,5-di-tert-butyl-4-hydroxybenzoate; and a triazine-based compound such as 2-(4,6-diphenyl-1,3,5-triazin-2-yl)-5-[(hexyl)oxy]phenol, and among others, a hindered amine-based compound is preferred.

Specific examples of the filler include a powder of crystalline silica, fused silica, alumina, zircon, calcium silicate, calcium carbonate, silicon carbide, silicon nitride, boron nitride, zirconia, forsterite, steatite, spinel, titania, talc, and the like, and beads obtained by spheroidization thereof.

These various additives can be used, if desired, in a range of 0 to 3 wt %. In the case where such various additives are present in the resin composition of the present invention, the weight ratio of the additive in the photocurable transparent adhesive composition is from 0.01 to 3 wt %, preferably from 0.01 to 1 wt %, more preferably front 0.02 to 0.5 wt %.

The resin composition of the present invention can be obtained by mixing and dissolving the component (A), the component (B), the component (C) and, if desired, the above-described optional components at a temperature from normal temperature to 80° C. In the resin composition for adhesion of the present invention, from the viewpoint of coatability, the blending ratio of the components is preferably adjusted appropriately so that the viscosity at 25° C. can be from 300 to 15,000 mPa·s.

The shrinkage percentage on curing of the cured product of the resin composition of the present invention is preferably 3.0% or less, more preferably 2.0% or less, and most preferably 1% or less. With this shrinkage percentage on curing, the internal stress accumulated in the resin cured product when curing the ultraviolet-curable resin composition can be reduced, and a distortion can be effectively prevented from occurring at the interface between the substrate and a layer composed of the cured product of the ultraviolet-curable resin composition.

Furthermore, in the case where the substrate such as glass is thin, if the shrinkage percentage on curing is large, warpage during curing is increased to give a great adverse effect on the display performance, and also from this viewpoint, the shrinkage percentage on curing is preferably smaller.

In addition, the cured product above preferably has flexibility. The flexibility is, in terms of Type E durometer value, preferably 20 or less, more preferably 15 or less, still more preferably less than 10.

The cured product of the resin composition of the present invention preferably has a transmittance of 90% or more at 400 to 800 nm. If the transmittance is less than 90%, the cured product can hardly transmit light and when used in a display device, causes deterioration in the visibility.

Also, when the transmittance at 400 to 430 nm of the cured product is high, the visibility can be expected to be more improved. Therefore, the transmittance at 400 to 450 nm is preferably 90% or more.

The resin composition of the present invention is excellent also in reworkability.

Usually, the reworking is performed by heating the substrates laminated together and cleaving the adhesive layer by means of a wire to separate the substrate from the adhesive layer. At this time, a solvent is used for facilitating the separation, and in the present invention, since the components of the composition are excellent in the releasability, even if alcohols such as isopropyl alcohol are used as the solvent the separation can be easily achieved.

The resin composition of the present invention is very useful as a photocurable transparent adhesive for obtaining an optical member where at least two substrates are laminated together. Out of two substrates laminated together, at least one substrate is a transparent substrate so as to transmit light for curing the adhesive.

The optical member can be obtained by coating the resin composition of the present invention on the lamination surface of at least either one substrate out of two substrates to be laminated together, thereby forming a coating layer, then laminating together the lamination surfaces of two substrates to sandwich the coating layer therebetween, and irradiating the coating layer with an ultraviolet light from the transparent substrate side to cure the coating layer.

More specifically, for example, the resin composition is coated on one substrate by using a coating device such as slit coater, roll coater, spin coater and screen printing method so that the coated resin can have a film thickness of 10 to 300 μm, another substrate is laminated therewith, and the coated resin is cured through irradiation with ultraviolet to near-ultraviolet light (at a wavelength around 200 to 400 nm), whereby an optical member having at least two substrates laminated together can be obtained. The irradiation dose is preferably from about 50 to 3,000 mJ/cm², more preferably on dm order of 100 to 2,000 mJ/cm². In the curing through irradiation with ultraviolet to near-ultraviolet light, the light source is not limited as long as it is a lamp capable of emitting ultraviolet to near-ultraviolet light. The light source includes, for example, a low-pressure, high-pressure or ultrahigh-pressure mercury lamp, a metal halide lamp, a (pulsed) xenon lamp, and an electrodeless lamp.

Preferred embodiments of the resin composition of the present invention are exemplified below.

In the following, unless otherwise Indicated, % is wt %.

(i) An ultraviolet-curable resin composition (hereinafter, simply referred to as the composition) being used to laminate together at least two substrates and containing (A) a (meth)acrylic polymer having a weight average molecule weight of 1,500 to 30,000 , (B) a (meth)acrylate compound having a (meth)acrylic equivalent of 200 g/eq. or more and having at least two acryloyl groups, and (C) a photopolymerization initiator, wherein the content of the (meth)acrylic polymer (A) is from 20 to 95% based on the total amount of the composition and the remainder is composed of the (meth)acrylate compound (B) and the photopolymerization initiator (C).

(ii) The composition as described in (i) above, wherein the content of the (meth)acrylic polymer (A) is from 50 to 95%.

(iii) The composition as described in (i) above, wherein the content of the (meth)acrylic polymer (A) is from 70 to 90%.

(iv) An ultraviolet-curable resin composition (hereinafter, simply referred to as the composition) being used to laminate together at least two substrates and containing (A) a (meth)acrylic polymer having a weight average molecule weight of 1,500 to 30,000, (B) a (meth)acrylate compound having a (meth)acrylic equivalent of 200 g/eq. or more and having at least two acryloyl groups, and (C) a photopolymerization initiator, wherein the content of the (meth)acrylate compound (B) is from 5 to 40% based on the total amount of the composition and the remainder is composed of the (meth)acrylic polymer (A) and the photopolymerization initiator (C).

(v) The composition as described in (iv) above, wherein the content of the (meth)acrylate compound (B) is from 10 in 30%.

(vi) The composition as described in (i) above, wherein the content of the (meth)acrylic polymer (A) is from 48 to 92%, the content of the (meth)acrylate compound (B) is from 5 to 40%, and the content of the photopolymerization initiator (C) is from 3 to 12%.

(vii) The composition as described in any one of (i) to (vi) above, wherein the (meth)acrylic polymer (A) is a (meth)acrylic polymer obtained by polymerizing monomers containing at least one monomer selected from alkyl (meth)acrylates having a carbon number of 1 to 10, which may have a hydroxy group.

(viii) The composition as described in (vii) above, wherein the (meth)acrylic polymer (A) is a (meth)acrylic polymer containing a component derived from at least one monomer selected from alkyl (meth)acrylates having a carbon number of 1 to 10, which may have a hydroxy group, in an amount of at least 50 mol % based on the total molar number of components derived from all monomers.

(ix) The composition as described in (vii) above, wherein the (meth)acrylic polymer (A) is a (meth)acrylic polymer obtained by polymerizing at least one monomer selected from alkyl (meth)acrylates having a carbon number of 1 to 10, which may have a hydroxy group.

(x) The composition as described in any one of (vii) to (ix) above, wherein the alkyl (meth)acrylate having a carbon number of 1 to 10, which may have a hydroxy group, is at least one monomer selected from the group consisting of methyl (meth)acrylate, n-butyl (meth)acrylate, 2-ethylhexyl (meth)acrylate, octyl (meth)acrylate; 2-hydroxyethyl (meth)acrylate and hydroxybutyl (meth)acrylate.

(xi) The composition as described in any one of (i) to (x) above, wherein the weight average molecular weight of the (meth)acrylic polymer (A) is from 3,000 to 20,000.

(xii) The composition as described in any one of (xi) to (x) above, wherein the weight average molecular weight of the (meth)acrylic polymer (A) is from 5,000 to 15,000.

(xiii) The composition as described in any one of (i) to (xii) above, wherein the (meth)acrylate compound (B) is a (meth)acrylate compound having a (meth)acrylic equivalent of 200 g/eq. or more and having two acryloyl groups.

(xiv) The composition as described in (xiii) above, wherein the (meth)acrylic equivalent is at least 250 g/eq.

(xv) The composition as described in (xiii) above, wherein the (meth)acrylic equivalent is at least 300 g/eq.

(xvi) The composition as described in (xiii) above, wherein the (meth)acrylic equivalent is at least 350 g/eq.

(xvii) The composition as described in any one of (xiii) to (xvi) above, wherein the (meth)acrylic equivalent is at most 3,000.

(xviii) The composition as described in (xvii) above, wherein the (meth)acrylic equivalent is at most 1,500.

(xix) The composition as described in (xvii) above, wherein the (meth)acrylic equivalent is at most 1,200.

(xx) The composition as described in any one of (i) to (xix) above, wherein the (meth)acrylate compound (B) is a di(meth)acrylate having caprolactone modification or a poly C3-C4 alkylene glycol di(meth)acrylate.

(xxi) The composition as described in (xx) above, wherein the (meth)acrylate compound (B) is at least one compound selected from the group consisting of caprolactone-modified hydroxypivalic acid neopentyl glycol diacrylate, polypropylene glycol diacrylate and polytetramethylene glycol diacrylate.

(xxii) The composition as described in any one of (i) to (xxi) above, wherein the shrinkage percentage on curing of the cured product is 3% or less.

(xxiii) The composition as described in (xxii) above, wherein the shrinkage percentage on curing of the cured product is 2% or less.

(xxiv) The composition as described in (xxii) above, wherein the shrinkage percentage on curing of the cured product is 1% or less.

(xxv) The composition as described in any one of (i) to (xxiv) above, wherein the flexibility of the cured product as measured by a Type E durometer is 20 or less in terms of Type E durometer value.

(xxvi) The composition as described in (xxv) above, wherein the flexibility is 15 or less in terms of Type E durometer value.

(xxvii) The composition as described in (xxv) above, wherein the flexibility is 10 or less in terms of Type E durometer value.

(xxviii) The composition as described in any care of (i) to (xxii) above, wherein the refractive index of the cured product is from 1.45 to 1.55.

(xxix) The composition as described in any one of (i) to (xxviii) above, wherein the (meth)acrylic polymer (A) is a (meth)acrylate polymer.

The resin composition of the present invention can be suitably used for obtaining an optical member by laminating together two or more substrates (preferably optical substrate). The substrate is not particularly limited but is preferably a plate-like or sheet-like optical substrate. Examples of the plate-like or sheet-like optical substrate include a plate such as transparent plate, a sheet, a display body (image display device), a touch panel, and the later-described optical functional material.

In addition, the resin composition of the present invention can be suitably used as an adhesive for laminating together a plurality of transparent plates in a touch panel.

As the material of the transparent plate, various materials can be used. Specifically, a transparent plate or sheet produced from polyethylene terephthalate (PET), polycarbonate (PC), polymethyl methacrylate (PMMA), a composite material of PC and PMMA, glass, a cycloolefin copolymer (COC), a cycloolefin polymer (COP), triacetyl cellulose (TAC) or a resin (plastic) such as acrylic resin; a functional transparent laminated plate or sheet obtained by stacking a plurality of those transparent plates or sheets, such as polarizing plate; a transparent plate produced from inorganic glass {inorganic glass plate, and a processed product thereof (for example, lens, prism and ITO glass)}; and the like can be used.

The resin composition of the present invention can also be used as an adhesive for laminating a sheet or a plate on a touch panel.

Here, the sheet includes an icon sheet, a decorative sheet and a protective sheet, and the plate includes a decorative plate and a protective plate (hereinafter, these sheets or plates arc sometimes collectively referred to as a substrate for protection). As the material of the sheet or plate, those recited as the material of the transparent plate can be applied. Also, the material for the touch surface of a touch panel includes glass, PET, PC, PMMA, a composite material of PC and PMMA, COC, and COP.

In the present invention, the touch panel can be obtained, for example, by coating the resin composition of the present invention on at least either one of the lamination surface of the substrate for protection or the touch surface of a touch panel to form a coating layer, laminating together both members to sandwich the coating layer between the lamination surface of the substrate for protection and the touch surface of the touch panel, and curing the coating layer through irradiation with an ultraviolet ray. That is, the touch panel of the present invention having a substrate for protection on the touch surface can be obtained.

The resin composition of the present invention can also be suitably used for laminating an optical functional material (substrate) on the display surface of a display device such as liquid crystal display device. The display device includes a liquid display device (LCD) in which a polarizing plate is attached to glass, and a display device such as EL (electroluminescence) display, EL lighting, electronic paper and plasma display. The optical functional material (substrate) includes a transparent plastic plate such as acrylic plate, PC plate, PET plate and PEN plate.

The display device of the present invention can be obtained by coating the resin composition of the present invention on at least either one surface of the display surface of a display device or the lamination surface of the above-described optical functional material to form a coating layer, laminating together both members to sandwich the coating layer between the display surface of the display device and the lamination surface of the optical functional material, and curing the coating layer through irradiation with an ultraviolet ray. Accordingly, the display device of the present invention is a display device in which an optical functional material is laminated on the display surface by means of a cured product layer of the resin composition of the present invention.

The display device with a touch panel of the present invention has a structure where a substrate for protection, a touch panel and a display device are sequentially stacked in this order and respective members are laminated together by an adhesive, and has a structure where at least either one of a pair of the substrate for protection and the touch surface of the touch panel or a pair of the display surface in the display device and the substrate surface opposite the touch surface of the touch panel are laminated together by means of a cured product layer of the resin composition of the present invention.

In the case of using the resin composition of the present invention as an adhesive for laminating together a transparent plate and the like, the refractive index of its cured product is preferably from 1.45 to 1.55 for enhancing the visibility.

With a refractive index in the range above, the difference in refractive index from the substrate used as a transparent plate can be decreased, and the light loss can be reduced by suppressing diffuse reflection of light.

Preferred embodiments of the optical member of the present invention are exemplified below.

(I) An optical member fabricated by laminating together at least two substrates by means of a cured product layer of the ultraviolet-curable resin composition described in any one of (i) to (xxix) above or the ultraviolet-curable resin composition described in any one of (9) to (18) set forth in the paragraph of MEANS FOR SOLVING THE PROBLEMS.

(II) The optical member as described in (I) above, wherein the optical member is a touch panel.

(III) The optical member as described in (II) above, wherein one substrate is a substrate for protection and another substrate is a touch panel.

(IV) The optical member as described in (I) above, wherein one substrate is an optical functional material and another substrate is a display surface.

(V) The optical member as described in (I) above, wherein three members of a substrate for protection, a touch panel and a display device are used as the substrate, these three members are stacked in order, respective substrates are adhered by an adhesive layer, and at least any one adhesive layer is the cured product layer.

(VI) The optical member as described in (I) above, wherein a substrate for protection and a display device are used as the substrate, the substrate for protection is stacked on the display surface of the display device, and both members are adhered by means of the cured product layer.

A display panel fabricated by laminating together a display device and an optical functional material by means of the resin composition of the present invention can be incorporated into an electronic device such as television, small game machine, cellular phone and personal computer.

### EXAMPLES

The present invention is described in greater detail below by referring to Examples, but the present invention is not limited to these Examples by any means.

Raw material compounds in each of Examples 1 to 6 and Comparative Examples 1 and 2 were uniformly mixed to give the composition shown in Table 1, whereby each ultraviolet-curable resin composition was prepared.

TABLE 1

| | | | | | | | | Comparative | Comparative |
|---|---|---|---|---|---|---|---|---|---|
| | | Example 1 | Example 2 | Example 3 | Example 4 | Example 5 | Example 6 | Example 1 | Example 2 |
| Component (A) | UP-1170 | 80 | | 80 | 80 | 80 | 80 | 80 | 80 |
| | UH-2190 | | 80 | | | | | | |
| Component (B) | HX-220 | 20 | | | | | | | |
| | HX-620 | | 20 | | | | | | |
| | FA-P270A | | | 20 | | | | | |
| | FA-P2100A | | | | 20 | | | | |
| | FA-P2200A | | | | | 20 | | | |
| | FA-PTG9A | | | | | | 20 | | |
| | TPGDA | | | | | | | 20 | |
| | SR-495B | | | | | | | | 20 |
| Component (C) | IRGACURE 184 | 3 | 3 | 3 | 3 | 3 | 3 | 3 | 3 |

| | | | | | | | | |
|---|---|---|---|---|---|---|---|---|
| Curability | A | A | A | A | A | A | A | C |
| | | | | | | | | (not cured) |
| Shrinkage percentage on curing | A | AA | AA | AA | AA | A | C | not evaluated |
| (%) | 1.2 | 0.9 | 0.8 | 0.7 | 0.7 | 1.2 | 4.1 | |
| Adhesiveness | A | A | A | A | A | A | C | |
| Flexibility | A | AA | AA | AA | AA | A | C | |
| (Type E durometer) | 12 | 9 | 8 | 6 | 5 | 10 | 40 | |
| Transparency | A | A | A | A | A | A | A | |

In Table 1, the components indicated by abbreviations are as follows.
UP-1170: Acrylic polymer, weight average molecular weight: 8,000, produced by Toagosei Co., Ltd.
UH-2190: Acrylic polymer, weight average molecular weight: 6,000, produced by Toagosei Co., Ltd.
HX-220: Caprolactone-modified hydroxypivalic acid neopentyl glycol diacrylate, (meth)acrylic equivalent: 270, produced by Nippon Kayaku Co., Ltd.
HX-620: Caprolactone-modified hydroxypivalic acid neopentyl glycol diacrylate, (meth)acrylic equivalent: 384, produced by Nippon Kayaku Co., Ltd.
FA-P270A: Polypropylene glycol diacrylate, (meth)acrylic equivalent: 412, produced by Hitachi Chemical Co., Ltd.
FA-P2100A: Polypropylene glycol diacrylate, (meth)acrylic equivalent 555, produced by Hitachi Chemical Co., Ltd.
FA-P2200A: Polypropylene glycol diacrylate, (meth)acrylic equivalent: 1055, produced by Hitachi Chemical Co., Ltd.
FA-PTG9A: Polytetramethylene glycol diacrylate, (meth)acrylic equivalent: 379, produced by Hitachi Chemical Co., Ltd.
TPGDA: Tripropylene glycol diacrylate, (meth)acrylic equivalent: 150, produced by Sartomer Company, Inc.
SR-495B: Caprolactone-modified hydroxyethyl acrylate, (meth)acrylic equivalent: 344, produced by Sartomer Company, Inc.
IRGACURE 184: 1-Hydroxycyclohexyl phenyl ketone, produced by BASF.

Following evaluations were performed using the obtained ultraviolet-curable resin composition of the present invention or the ultraviolet-curable resin composition of Comparative Example.

### Curability:

Two sheets of slide glass of 1 mm in thickness were laminated together such that the film thickness of the obtained ultraviolet-curable resin composition becomes 200 μm, and after performing ultraviolet irradiation of 2,000 mJ/cm² through the glass from a high-pressure mercury lamp (80 W/cm, ozoneless), the cured state was checked.

A: Completely cured

B: Half-cured

C: Uncured

### Shrinkage Percentage on Curing:

Two sheets of fluorine-based release agent-coated slide glass of 1 mm in thickness were laminated together such that the film thickness of the obtained ultraviolet-curable resin composition becomes 200 μm, and curing was performed by ultraviolet irradiation of 2,000 mJ/cm² through the glass from a high-pressure mercury lamp (80 W/cm, ozoneless) to produce a cured product for measurement of film specific gravity. The specific gravity (DS) of the cured product was measured in accordance with JIS K7112, Method B. Also, the liquid specific gravity (DL) of the resin composition was measured at 25° C. and the shrinkage percentage on curing was calculated by the following formula:

Shrinkage percentage on curing (%)=(DS−DL)÷DS×100

AA: Less than 1.0%

A: From 1.0% to less than 3.0%

C: 3.0% or more

### Adhesiveness:

Slide glass of 0.8 mm in thickness and an acrylic plate of 0.8 mm in thickness were laminated together such that the film thickness of the obtained ultraviolet-curable resin composition becomes 200 μm, and ultraviolet irradiation of 2,000 mJ/cm² through the glass from a high-pressure mercury lamp (80 W/cm, ozoneless) was performed to produce a sample for evaluation. The sample was left standing in an environment of 85° C. and 85% RH for 500 hours and checked with an eye for separation.

A: No separation was observed

C: Separation was observed.

### Flexibility;

The obtained ultraviolet-curable resin composition was thoroughly cured and evaluated for the flexibility by measuring the Type E durometer hardness in accordance with JIS K7215.

AA: less than 10

A: from: 10 to less than 20

B: from 20 to less than 40

C: 40 or more

### (Transparency)

Two sheets of fluorine-based release agent-coated slide glass of 1 mm in thickness were laminated together such that the film thickness of the obtained ultraviolet-curable resin composition becomes 200 μm, and ultraviolet irradiation of 2,000 mJ/cm² through the glass from a high-pressure mercury lamp (80 W/cm, ozoneless) was performed to produce a cured product for measurement of transparency. As for the transparency, the transmittance at 400 to 800 nm was measured using a spectrophotometer (U-3310, manufactured by Hitachi High-Technologies Corporation).

A: Transmittance of 98% or more

C: Transmittance of less than 98%

As seen from the results in Table 1, the resin composition of the present invention in Examples 1 to 6 containing a (meth)acrylic polymer having a specific weight average molecular weight and a (meth)acrylate compound having a (meth)acrylic equivalent of 200 g/eq. or more and having at least two (meth)acryloyl groups, is very useful as an optical transparent adhesive because of high curability, lesser shrinkage during curing, and excellent performance in terms of transparency of the cured product as well as in terms of adhesiveness to a substrate and flexibility of the cured product. On the other hand, with the (meth)acrylate compound of Comparative Example 1 having a (meth)acrylic equivalent of less than 200 and having two or more (meth)acryloyl groups or with the (meth)acrylate compound of Comparative Example 2 having a (meth)acrylic equivalent of 200 or more and having one (meth)acryloyl group, the object of the present invention could not be attained.

### Industrial Applicability

The ultraviolet-curable resin composition of the present invention used for laminating together two substrates exhibits good adhesiveness to a substrate and small shrinkage percentage on curing and is provided with flexibility and pod visible light transmittance and therefore, useful for obtaining an optical member by laminating together optical substrates. In particular, the resin composition is useful for laminating together optical substrates in a touch panel or a display device with a touch panel.

1. An optical member, comprising:
at least two substrates; and
a cured product layer of an ultraviolet-curable resin composition containing (A) a (meth)acrylic polymer having a weight average molecule weight of 1,500 to 30,000, (B) a (meth)acrylate compound having a (meth)acrylic equivalent of 200 g/eq. or more and having at least two (meth)acryloyl groups, and (C) a photopolymerization initiator,
wherein the at least two substrates are laminated together by means of the cured product layer.

2. The optical member according to claim 1, wherein a shrinkage percentage on curing of the ultraviolet-curable resin composition is 3% or less.

3. The optical member according to claim 1, wherein the ultraviolet-curable resin composition gives a cured product having a flexibility value of less than 20 as measured by a Type E durometer.

4. The optical member according to claim 1, wherein the (meth)acrylic polymer (A) is a (meth)acrylic polymer obtained by polymerizing monomers containing at least one monomer selected from the group consisting of alkyl (meth)acrylates having a carbon number of 1 to 10, which may have a hydroxy group.

5. The optical member according to claim 1, wherein the (meth)acrylate compound (B) is a di(meth)acrylate having caprolactone modification or a poly C3-C4 alkylene glycol di(meth)acrylate.

6. The optical member according to claim 1, wherein the (meth)acrylic polymer (A) is a (meth)acrylic polymer obtained by polymerizing monomers containing at least one monomer selected from the group consisting of alkyl (meth)acrylates having a carbon number of 1 to 10, which may have a hydroxy group, and
the (meth)acrylate compound (B) is a di(meth)acrylate having caprolactone modification or a poly C3-C4 alkylene glycol di(meth)acrylate.

7. The optical member according to claim 1, wherein the (meth)acrylic polymer (A) is a (meth)acrylic polymer obtained by polymerizing at least one monomer selected from the group consisting of methyl (meth)acrylate, n-butyl (meth)acrylate, 2-ethylhexyl (meth)acrylate, octyl (meth)acrylate, 2-hydroxyethyl (meth)acrylate and hydroxybutyl (meth)acrylate, and
the (meth)acrylate compound (B) is at least one compound selected from the group consisting of caprolactone-modified hydroxypivalic acid neopentyl glycol diacrylate, polypropylene glycol diacrylate and polytetramethylene glycol diacrylate.

8. The optical member according to claim 1, wherein the ultraviolet-curable resin composition is a resin composition containing, based on the entire composition, from 48 to 92 wt % of the (meth) acrylic polymer (A), from 5 to 40 wt % of the (meth) acrylate compound (B) and from 3 to 12 wt % of the photopolymerization initiator (C).

9. An ultraviolet-curable resin composition, which is used to laminate at least two substrates together and comprises:
(A) a (meth)acrylic polymer having a weight average molecule weight of 1,500 to 30,000;
(B) a (meth)acrylate compound having a (meth)acrylic equivalent of 200 g/eq. or more and having at least two acryloyl groups; and
(C) a photopolymerization initiator.

10. The ultraviolet-curable resin composition according to claim 9, which is an ultraviolet-curable resin composition having a shrinkage percentage on curing of 3% or less.

11. The ultraviolet-curable resin composition according to claim 9, which gives a cured product having a flexibility value of less than 20 as measured by a Type E durometer.

12. The ultraviolet-curable resin composition according to claim 9, which gives a cured product having a shrinkage percentage on curing of 3% or less and a flexibility value of less than 20 as measured by a Type E durometer.

13. The ultraviolet-curable resin composition according to claim 9, wherein the (meth)acrylic polymer (A) is a (meth)acrylic polymer obtained by polymerizing at least one monomer selected from the group consisting of alkyl meth)acrylates having a carbon number of 1 to 10, which may have a hydroxy group, and
the (meth)acrylate compound (B) is a di(meth)acrylate having caprolactone modification or a poly C3-C4 alkylene glycol di(meth)acrylate.

14. The ultraviolet-curable resin composition according to claim 9, wherein the (meth)acrylic polymer (A) is a (meth)acrylic polymer obtained by polymerizing at least one monomer selected from the group consisting of methyl (meth)acrylate, n-butyl (meth)acrylate, 2-ethylhexyl (meth)acrylate, octyl (meth)acrylate, 2-hydroxyethyl (meth) acrylate and hydroxybutyl (meth) acrylate.

15. The ultraviolet-curable resin composition according to claim 9, wherein the (meth)acrylate compound (B) is at least one compound selected from the group consisting of caprolactone-modified hydroxypivalic acid neopentyl glycol diacrylate, polypropylene glycol diacrylate and polytetramethylene glycol diacrylate.

16. The ultraviolet-curable resin composition according to claim 9, wherein the (meth)acrylic polymer (A) is a (meth)acrylic polymer obtained by polymerizing at least one monomer selected from the group consisting of methyl (meth)acrylate, n-butyl (meth)acrylate, 2-ethylhexyl (meth)acrylate, octyl (meth)acrylate, 2-hydroxyethyl (meth) acrylate and hydroxybutyl (meth) acrylate, and
the (meth)acrylate compound (B) is at least one compound selected from the group consisting of caprolactone-modified hydroxypivalic acid neopentyl glycol diacrylate, polypropylene glycol diacrylate and polytetramethylene glycol diacrylate.

17. The ultraviolet-curable resin composition according to claim 9, which is a resin composition containing, based on the entire composition, from 48 to 92 wt % of the (meth) acrylic polymer (A), from 5 to 40 wt % of the (meth) acrylate compound (B) and from 3 to 12 wt % of the photopolymerization initiator (C).

18. The ultraviolet-curable resin composition according to claim 9, wherein a content of the (meth)acrylic polymer (A) is from 70 to 95 wt % based on the entire composition.

19. The ultraviolet-curable resin composition according to claim 9, wherein a content of the (meth)acrylate compound (B) is from 10 to 30 wt % based on the entire composition.

20. The ultraviolet-curable resin composition according to claim 9, wherein a content of the (meth) acrylic polymer (A) is from 70 to 95 wt % based on the entire composition and a shrinkage percentage on curing is 3.0% or less.

21. A cured product, obtained by irradiating the ultraviolet-curable resin composition according to claim 9 with an active energy ray.

22. A touch panel, comprising:
at least two substrates; and
a cured product of the ultraviolet-curable resin composition according to claim 9, wherein the at least two substrates are laminated together by means of the cured product.

23. A display device with a touch panel, comprising:
at least two substrates; and
a cured product of the ultraviolet-curable resin composition according to claim 9, wherein the at least two substrates are laminated together by means of the cured product.
